(19) United States
(12) Patent Application Publication
(10) Pub. No.: US 2004/0028914 A1
(43) Pub. Date: Feb. 12, 2004

(54) Water-repellent, oil-repellent and soil resistant coating composition

(76) Inventor: Hideto Yanome, Kanagawa (JP)

Correspondence Address: 3M INNOVATIVE PROPERTIES COMPANY, PO BOX 33427, ST. PAUL, MN, 55133-3427, US

(21) Appl. No.: 10/415,527

(22) PCT Filed: Nov. 9, 2001
(86) PCT No.: PCT/US01/47029

(30) Foreign Application Priority Data
Nov. 16, 2000 (JP) 2000-350089

(51) Int. Cl. B32B 9/04

(52) U.S. Cl. 428/447

(57) ABSTRACT

A coating composition capable of providing a coating film which has sufficiently high water repellency, oil repellency and soil resistance and which ensures high adhesion property to a substrate. A coating composition comprising a copolymer obtained by copolymerizing monomers comprising a fluoroaliphatic group-containing unsaturated ester monomer and an unsaturated silane monomer.

### FIELD OF THE INVENTION

The present invention relates to a surface coating composition, more specifically, a moisture-proof and oil-resistant coating composition for the application to the surface of parts of electronic instruments.

### BACKGROUND

A coating agent comprising a compound having a long-chain fluoroaliphatic group typically exhibits a lower critical surface tension as compared with other materials, and therefore this has been heretofore widely used as a surface modifier for attaining water repellency, oil repellency and soil resistance. Such modifiers which are now used typically include a homopolymer or a copolymer obtained by radical polymerization of an α,β-unsaturated ester monomer having a fluoroaliphatic group. These polymers are, however, low in the surface hardness and do not exhibit sufficiently high abrasion resistance and durability. Furthermore, these polymers tend to be inadequate film-formers and in adhering to a substrate. Therefore, coating films of such polymers are disadvantageously peeled off by just a light rubbing. Also, the bond to a substrate is attained by hydrogen bonding; therefore the bonding force is weak and when water is splashed on the edge surface of the coating film, the coating film is disadvantageously peeled off.

U.S. Pat. Nos. 3,931,454 and 4,849,291 describe coating compositions comprising a fluoroalkyl (meth)acrylate/(meth)acrylic acid copolymer where a part of fluoroalkyl (meth)acrylate is displaced by (meth)acrylic acid. The references teach that by introducing (meth)acrylic acid into the copolymer, the adhesion property to a substrate is improved. However, even by such improvement, the above-described problem cannot be completely overcome.

Japanese Unexamined Patent Publication (Kokai) No. 58-172245 discloses, as a treating agent for imparting water repellency, oil repellency, soil resistance and low reflection property to a glass surface, a glass surface treating agent, comprising:

(a) a polyfluoroalkyl group-containing silane compound represented by the formula:

{Rf(X)ₙCON(R¹)—A}ₐSi(Z)_{b}Y¹_{4-a-b} (I)

or a partially hydrolyzed condensate thereof and

(b) a silane compound represented by the formula

SiR²_{c}Y²_{4-c},

wherein Rf is a polyfluoroalkyl group having from 1 to 20 carbon atoms, which may have one or more ether bonds, R¹ and R² each is a hydrogen atom or a lower alkyl group, X is —CON(R²)—Q— or —SO₂N(R²)—Q—0 (wherein R² is the same as above and Q is a divalent organic group), A is an alkylene group, Z is a lower alkyl group, Y¹ and Y² each is a halogen, an alkoxy group or R³COO— (wherein R³ is a hydrogen atom or a lower alkyl group), n is an integer of 0 or 1, a is an integer of 1 to 3, b is an integer of 0 or 1 to 2, and c is an integer of 0 or 1 to 2). By using the above-described polyfluoroalkyl group-containing silane compound mixed with alkoxy or halogenosilane, the crosslinking degree on the surface adhering to glass increases and thereby the adhesion property, water repellency and oil repellency are improved. However, in this treating agent, the component (a) has an Rf:Si ratio of 1:1 and the component (b) contains Si, as a result, the density of Rf group in the entire composition is low and silicon is contained in a large amount. If the silicon content is large, oil repellency of the composition is disadvantageously inhibited. Furthermore, the component (a) contained in the treating agent has a low molecular weight, and therefore it is difficult to form a uniform coating film and the permeation resistance to oil of the film is considered to be low.

A coating composition not containing the above-described low molecular weight fluoro-containing compound but containing a fluorine-containing polymer is also known. Japanese Unexamined Patent Publication (Kokai) No. 11-349888 discloses a coating composition comprising a fluororesin having an aliphatic ring structure in the main chain, a partially hydrolyzed condensate of alkoxysilane and a solvent. The partially hydrolyzed condensate of alkoxysilane in this composition is expected to act to overcome the defects in physical properties of the fluororesin, such as low glass transition temperature and small modulus and high coefficient of linear expansion at high temperatures. In the adhering to a substrate, this composition is considered to be bonded to the substrate through the partially hydrolyzed condensate of alkoxysilane, because the fluororesin usually exhibits low adhesion to a substrate. The reference teaches that in order to improve the adhesive property to a substrate, a compound having a hydrolyzable group capable of reacting with the partially hydrolyzed condensate of alkoxysilane and a site capable of reacting with the functional group of the fluororesin can be used as a coupling agent. However, with this composition, direct adhesion between the fluororesin and the substrate cannot be attained interfering with formation of a uniform coating film having sufficiently high water repellency, oil repellency and soil resistance.

Accordingly, the need exists for a coating composition capable of providing a coating film having sufficiently high water repellency, oil repellency and soil resistance and ensuring high adhesion property to a substrate.

### SUMMARY OF INVENTION

In brief summary, the present invention provides a coating composition comprising a copolymer obtained by copolymerizing monomers comprising a fluoroaliphatic group-containing unsaturated ester monomer and an unsaturated silane monomer.

When this coating composition is used, a coating having sufficiently high water repellency, oil repellency and soil resistance and ensuring high adhesion property to a substrate can be obtained.

### DETAILED DESCRIPTION OF ILLUSTRATIVE EMBODIMENTS

The fluoroaliphatic group-containing unsaturated ester monomer for the copolymer in the composition of the present invention acts to impart water repellency, oil repellency and soil resistance to the resultant coating. The ester monomer is a compound which contains an aliphatic group at least partially substituted by fluorine, particularly an alkyl group at least partially substituted by fluorine, and which has a polymerizable ethylenic unsaturated carbon-carbon double bond. More specifically, the fluoroaliphatic group-containing unsaturated ester monomer includes a compound represented by the following formula:

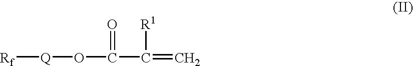

wherein Rf is a linear, branched or cyclic and at least partially fluorinated, aliphatic group, for example, an at least partially fluorinated alkyl group, preferably a completely fluorinated alkyl group having from 2 to 12 carbon atoms, R¹ is H or CH₃, and Q is a lower alkylene group, for example, —CH₂— or —CH₂CH₂, or —SO₂NR²-lower alkylene group, for example, —SO₂NR²—CH₂— or —SO₂NR²—CH₂CH₂—, wherein R² is hydrogen or a lower alkyl group, for example, —CH₃ or —C₂H₅.

As the number of carbon atoms or the number of fluorine substituents is larger in Rf, higher water repellency, higher oil repellency and higher soil resistance are obtained. However, if the number of carbon atoms is excessively large, the copolymer is considered likely to accumulate in vital tissues. Accordingly, Rf is preferably a fluoroaliphatic group having from 3 to 7 carbon atoms, more preferably from 3 to 6 carbon atoms. The terminal group of Rf is preferably a completely fluorinated —CF₃ group, because high water repellency, oil repellency and soil resistance are obtained.

In order not to inhibit the water repellency and the like of the copolymer, Q is a lower alkylene group, preferably —CH₂— or —CH₂CH₂—. Specific examples of the monomer include F(CF₂)₆CH₂OC(═O)C(CH₃)═CH₂, C₇F₁₅SO₂N(C₂H₅)C₂H₄OC(═O)C(CH₃)═CH₂, c—C₆F₁₁CH₂OC(═O)C(CH₃)═CH₂, C₆F₁₃C₂H₄OC(═O)CH═CH₂, (CF₃)₂CF(CF₂)₂C₂H₄OC(═O)CH═CH₂, H(CF₂)₄CH₂OC(═O)CH═CH₂, F(CF₂)₄C₂H₄OC(═O)CH═CH₂ and F(CF₂)₃CH₂OC(═O)CH═CH₂. These monomers can be produced by conventional methods, for instance, as described in U.S. Pat. Nos. 2,803,615 and 2,841,573.

The fluoroaliphatic group-containing unsaturated ester monomer typically constitutes at least 50 wt % or more, preferably 70 wt % or more, based on the total weight of the ester monomer and the unsaturated silane monomer. With this range, sufficiently high water repellency, oil repellency and soil resistance can be imparted to the coating.

The unsaturated silane monomer portion of the copolymer facilitates adhesion of the resultant coating to a substrate. The unsaturated silane monomer is a silane-type compound containing a silicon atom capable of increasing the adhesion property to a substrate and also having a polymerizable ethylenic unsaturated carbon-carbon double bond. More specifically, the unsaturated silane monomer includes a compound represented by the following formula:

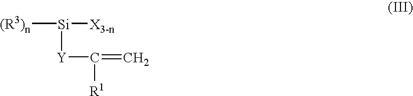

wherein R¹ is H or CH₃, R³ is hydrogen or a lower alkyl group, for example, a methyl or ethyl group, X is alkoxy, halogen or RCOO—, wherein R is hydrogen or a lower alkyl group, for example, a methyl or ethyl group, Y is a single bond or —CH₂—, and n is an integer of 0, 1 or 2. Specific examples of the compound where X is an alkoxy group include vinyltrialkoxysilane such as (CH₃O)₃SiCH═CH₂ and (C₂H₅O)₃SiCH═CH₂, and allyltrialkoxysilane such as (CH₃O)₃SiCH₂CH═CH₂. Specific examples of the compound where X is a halogen include CH₂═CHSiCl₃. Specific examples of the compound where X is RCOO— include (CH₃COO)₃SiCH═CH₂.

The unsaturated silane monomer usually constitutes an amount of 1 to 50 wt % based on the total weight of the fluoroaliphatic group-containing unsaturated ester monomer and the unsaturated silane monomer. If the silane monomer is contained at less than 1.0 wt %, the improvement effect on the adhesion property of the coating to a substrate may not be clearly brought out, whereas if it exceeds 50 wt %, the water repellency and the oil repellency may decrease. In view of the balance between the adhesion property of the coating to a substrate and the performance such as water repellency, the amount of the unsaturated silane monomer is preferably from 1 to 30 wt %, more preferably from 1 to 10 wt %, still more preferably from 1.5 to 4 wt %.

As long as the desired properties of coatings of the present invention such as water repellency, oil repellency, soil resistance and adhesion to a substrate are not undesirably impaired, the copolymer in the composition of the present invention may contain a monomer other than the above-described fluoroaliphatic group-containing unsaturated monomer and unsaturated silane monomer, which is copolymerizable with these monomers, such as (meth)acrylic acid, ethylene, olefin and styrene. However, typically the copolymer preferably consists essentially of above-described two kinds of monomers.

The copolymer may be produced by a conventional radical polymerization method. To speak more specifically, a fluoroaliphatic group-containing unsaturated ester monomer and an unsaturated silane monomer are dissolved in an appropriate solvent such as hydrofluorocarbon ether in the presence of a radical polymerization initiator such as azobisisobutyronitrile and then polymerized under heating at 60 to 75° C. for 10 to 20 hours, whereby the copolymer can be obtained.

The copolymer in the coating composition preferably has a molecular weight of 100 to 50,000, more preferably from 500 to 5,000. If the molecular weight is too small, poor film-forming performance may result, whereas if the molecular weight is excessively large, the viscosity of the coating composition typically tends to increase and it becomes more difficult to apply the resultant composition.

The coating composition preferably contains a solvent so as to improve the coatability. Preferably, the solvent utilized in the present invention is a fluorinated solvent. Illustrative examples of suitable fluorinated solvents include those which are non-ozone depleting and non-flammable, such as highly fluorinated hydrofluorocarbons (HFCs) and hydrofluorocarbon ethers (HFEs). The term “hydrofluorocarbon” as used herein means a compound containing carbon, hydrogen, fluorine and no other atoms. The term “hydrofluorocarbon ether” as used herein means a compound containing carbon, hydrogen, fluorine, one or more ether oxygen atoms, and optionally one or more additional catenary heteroatoms within the carbon backbone, such as trivalent nitrogen or sulfur, and being free of chlorine, bromine and iodine atoms.

HFCs and HFEs have low surface tension and low viscosity as compared with other organic solvents. Therefore, a uniform and continuous, i.e., pore-free, coating can be obtained even if the substrate to be covered has a complicated shape. As a result, even small spaces or small holes can be coated with the composition. Furthermore, the composition can be coated as a thin film. As compared with common ketone or ester solvents, HFCs and HFEs typically do not attack organic materials, and therefore can be effectively used even if the substrate is a resin, with confidence that the substrate will not be degraded by the solvent. In addition, HFCs and HFEs are very low in the water solubility, and therefore the coating composition obtained can be prevented from gelling due to the hydrolysis of the silane monomer unit of the copolymer and can be favored with high storage stability. Use of a solvent which readily absorbs moisture, such as alcohol, is typically not preferred because due to the partial hydrolysis of the silane monomer unit, the condensation proceeds and gelling is caused. HFCs and HFEs are preferably liquid and non-flammable at room temperature (about 20° C.) and atmospheric pressure (1 atm).

Illustrative examples of useful HFCs include those having a 3- to 8-carbon backbone, with 4- to 9-carbon backbone being preferred. The carbon backbone can be straight, branched, cyclic, or mixtures of these. Illustrative examples of useful HFCs include compounds having more than approximately 5 molar percent fluorine substitution and less than 95 molar percent fluorine substitution, based on the total number of hydrogen and fluorine atoms bonded to the carbon backbone. Preferred HFCs include CF₃CFHCFHCF₂CF₃, C₅F₁₁H, C₆F₁₃H, CF₃CF₂CH₂CH₂F, CHF₂CF₂CF₂CHF₂, 1,2-dihydroperfluorocyclopentane and 1,1,2-trihydroperfluorocyclopentane. Some illustrative examples of useful HFCs include HFCs available under the VERTREL™, available from E. I. duPont de Nemours & Co., and under the ZEORORA-H™, available from Nippon Zeon Co. Ltd., Tokyo, Japan.

Generally the more preferred fluorinated solvents are HFEs, as they exhibit the best combination of solvency along with optimum safety (non-flammability and low toxicity) and environmental (non-ozone depleting and low global warming) properties. HFEs are chemical compounds containing carbon, fluorine, hydrogen, one or more ether oxygen atoms, and optionally one or more additional catenary heteroatoms within the carbon backbone, such as sulfur or trivalent nitrogen. The HFE can be straight-chained, branched-chained, or cyclic, or a combination thereof, such as alkylcycloaliphatic. Preferably, the HFE is free of unsaturated portions.

These highly fluorinated ethers may be depicted by the formula below:

(R⁴—O)ₐR⁵ (IV)

wherein a is a number from 1 to 3 inclusive and R⁴ and R⁵ are the same or are different from one another and are selected from the group consisting of alkyl, aryl, and alkylaryl groups. At least one of R⁴ and R⁵ contains at least one fluorine atom, and at least one of R⁴ and R⁵ contains at least one hydrogen atom, either or both groups R⁴ and R⁵ can optionally contain one or more catenary heteroatoms, e.g., oxygen, sulfur, or nitrogen, and preferably the total number of fluorine atoms in the HFE at least equals the total number of hydrogen atoms. R⁴ and R⁵ may also be linear, branched, or cyclic, and may contain one or more unsaturated carbon-carbon bonds, though preferably R⁴ and R⁵ are both saturated.

Illustrative examples of suitable HFEs include: (1) segregated HFEs, wherein ether-bonded alkyl or alkylene, etc., segments of the HFE are either perfluorinated (e.g., perfluorocarbon) or non-fluorinated (e.g., hydrocarbon), but not partially fluorinated; and (2) non-segregated HFEs, wherein at least one of the ether-bonded segments is neither perfluorinated nor fluorine-free but is partially fluorinated (i.e., contains a mixture of fluorine and hydrogen atoms). Segregated HFEs are the most preferred fluorinated solvents as they demonstrate the shortest atmospheric lifetimes and lowest global warming potentials.

Segregated HFEs include HFEs which comprise at least one mono-, di-, or trialkoxy-substituted perfluoroalkane, perfluorocycloalkane, perfluorocycloalkyl-containing perfluoroalkane, or perfluorocycloalkylene-containing perfluoroalkane compound. These HFEs are described, for example, in PCT Publication No. WO 96/22356, and can be represented by the formula below:

R_{f}′—(O—Rₕ)ₓ (V)

wherein:

x is from 1 to about 3, and R_{f}′ is a perfluorinated hydrocarbon group having a valency x, which can be straight, branched, or cyclic, etc., and preferably contains from 2 to 9 carbon atoms, and more preferably contains from 3 to 6 carbon atoms;

each Rₕ is independently a linear or branched alkyl group having from 1 to 3 carbon atoms;

wherein either or both of the groups R_{f}′ and Rₕ can optionally contain one or more catenary heteroatoms; and

wherein the sum of the number of carbon atoms in the R_{f} group and the number of carbon atoms in the Rₕ group(s) is preferably between 4 and 10.

Preferably, x is 1. Most preferable R_{f}′ groups include C₃F₇-isomers (i.e., n-, iso-), C₄F₉-isomers (i.e., n-, iso-, sec-, tert-), C₅F₁₁-isomers, C₆F₁₃-isomers, and perfluorocyclohexyl; and most preferable Rₕ groups include methyl and ethyl.

Preferred segregated HFEs include n—C₃F₇OCH₃, (CF₃)₂CFOCH₃, n—C₄F₉OCH₃, (CF₃)₂CFCF₂OCH₃, n—C₃F₇OC₂H₅, n—C₄F₉OC₂H₅, (CF₃)₂CFCF₂OC₂H₅, (CF₃)₃COCH₃, (CF₃)₃COC₂H₅, CF₃CF(OCH₃)CF(CF₃)₂, CF₃CF(OC₂H₅)CF(CF₃)₂, CF₃CF₂CF₂CF(OC₂H₅)CF(CF₃)₂, CF₃CF(CF₃)CF₂OCH₃, CF₃CF(CF₃)CF₂OC₂H₅, C₈F₁₇OCH₃, CH₃O(CF₂)₄OCH₃, C₅F₁₁OC₂H₅, C₃F₇OCH₃, CF₃OC₂F₄OC₂H₅, C₃F₇OCF(CF₃)CF₂OCH₃, (CF₃)₂CFOCH₃, C₄F₉OC₂F₄OC₂F₄OC₂H₅, C₄F₉O(CF₂)₃OCH₃ and 1-dimethoxyperfluorocyclohexane, and mixtures thereof. Segregated HFEs are available as 3M™ NOVEC™ HFE-7100, HFE-7200 and HFE-7500 engineering fluids from Minnesota Mining and Manufacturing Company.

Also useful as fluorinated solvents are azeotropes and azeotrope-like compositions which are blends of segregated HFEs with non-halogenated organic compounds. Especially useful are the azeotropes and azeotrope-like compositions consisting of blends of organic solvents with C₄F₉OCH₃ (described in PCT Publication No. WO 96/36689), C₄F₉OC₂H₅ (described in PCT Publication No. WO 96/36688) and C₃F₇OCH₃ (described in PCT Publication No. WO 98/37163).

Illustrative examples of useful non-segregated HFEs include alpha-, beta- and omega-substituted hydrofluoroalkyl ethers such as those described in U.S. Pat. No. 5,658,962 (Moore et al.), incorporated herein by reference, and those described by Marchionni et al. in “Hydrofluoropolyethers,” Journal of Fluorine Chemistry 95 (1999), pp. 41-50, both of which can be described by the general structure shown below:

X′—[R_{f}″—O]_{y}R″H (VI)

wherein:

X′ is either F, H, or a perfluoroalkyl group containing from 1 to 3 carbon atoms which is optionally hydrosubstituted in the omega positions;

each R_{f}′ is independently selected from the group consisting of —CF₂—, —C₂F₄—, and —C₃F₆—, wherein, when X′ is perfluorinated, X′ and at least a portion of the adjacent R_{f}″ group taken together can form a perfluorocycloalkyl group;

R″ is a divalent organic radical having from 1 to 3 carbon atoms, and may be perfluorinated, unfluorinated or partially fluorinated; and

y is an integer from 1 to 7;

wherein when X′ is F, R″ contains at least one F atom; and wherein preferably the total number of carbon atoms is between 3 and 8.

Illustrative examples of non-segregated HFEs useful in the present invention include, but are not limited to, the following compounds:

C₄F₉OC₂F₄H

HC₃F₆OC₃F₆H

HC₃F₆OCH₃

C₅F₁₁OC₂F₄H

C₆F₁₃OCF₂H

C₃F₇OCH₂F

HCF₂OCF₂OCF₂H

HCF₂OCF₂OC₂F₄OCF₂H

HCF₂OC₂F₄OC₂F₄OCF₂H

C₃F₇O[CF(CF₃)CF₂O]ₚCF(CF₃)H, wherein p=0 to 1

HCF₂OC₂F₄OCF₂H

HCF₂OCF₂OCF₂OCF₂H

HCF₂OC₂F₄OC₂F₄OCF₂H

c—C₆F₁₁OCF₂H

c—C₆F₁₁OCF₂F

Preferred non-flammable, non-segregated HFEs include C₄F₉OC₂F₄H, C₆F₁₃OCF₂H, HC₃F₆OC₃F₆H, C₃F₇OCH₂F, HCF₂OCF₂OCF₂H, HCF₂OC₂F₄OCF₂H, HCF₂OCF₂OCF₂OCF₂H, HCF₂OCF₂CF₂OCF₂H, HC₃F₆OCH₃, HCF₂OCF₂OC₂F₄OCF₂H, and mixtures thereof. Several non-segregated HFEs useful herein are available from Ausimont Corp., Milano, Italy, under the GALDEN H™.

Coating compositions of the present invention may be coated by any conventional method, e.g., spin coating, dipping, potting, die coating or spray coating. The coating method is appropriately selected according to the shape of the substrate to be coated or the required thickness of the coating film. In the case where the coating composition contains a solvent, the composition may be heated after the coating on a substrate to remove the solvent. It is considered that the monomer moiety derived from the silane unsaturated monomer in the copolymer is hydrolyzed and causes a chemical reaction with a functional group on the substrate, such as OH group, whereby a coating film having high adhesion property is formed on a substrate. This hydrolysis easily takes place at room temperature using the moisture content in the environment. Therefore, even if a special treatment is not applied to the coating solution after the coating, a coating film having high adhesion property can be formed at a sufficiently high speed. Of course, the coating composition may be coated by elevating the substrate temperature and increasing the environmental moisture content at the time of coating. Furthermore, a quick dry treatment such as baking may also be performed.

Coating compositions of the present invention can form coating films having good adhesion property on any of organic, inorganic and metal substrates. For example, coating compositions of the present invention can be used as an oil diffusion-preventing coating (a coating for preventing, for example, diffusion of motor axis lubricating oil, diffusion of lubricating oil for gear shaft of clock parts or the like, leakage of lubricating grease for bearing, or diffusion of grease for sliding parts), a moisture-proof coating (a coating for moisture proofing of, for example, clock parts, precision instrument parts, electric substrate, capacitor or sensor), an insulating coating (insulation of, for example, capacitor or sensor), an antireflection coating (for example, pellicle film or protective film of pellicle film), an antifouling coating (a coating for, for example, preventing adhesion of fingerprint, oil or dusts to the optical or electronic parts, improving capability of removing these adhered soils, preventing flux creeping, or preventing an organic material from adhering to HDD head) or a weather-resistant protective coating (a coating for protecting, for example, an electric substrate from moisture, water droplet or oil).

### EXAMPLES

The present invention is further described in the following illustrative Examples.

### Production of Coating Composition

Into a reactor, fluoroalkyl (meth)acrylate (fluoroaliphatic group-containing unsaturated ester monomer) and vinyl alkoxysilane (unsaturated silane monomer) were charged. Thereto, n—C₄F₉OC₂H₅ as a solvent and azobisisobutyronitrile (ABIN) as an initiator were added. The resulting mixture was shaken by a shaker for about 5 minutes to completely dissolve the monomers and initiator and therein, dry nitrogen was bubbled for about 3 minutes using a glass Pasteur. Then, the reactor was sealed and set in a rotary constant temperature water bath to allow the polymerization to proceed at 65° C. for 16 hours. Thereafter, the reactor was taken out from the constant temperature water bath and then allowed to cool to room temperature. The reaction solution was transferred to a measuring flask and the solvent was removed by an evaporator. As a result, a transparent fluororesin copolymer was obtained and the weight thereof was measured. Again, n—C₄F₉OC₂H₅ was added to have a fluororesin concentration of 2 wt % and under irradiation of ultrasonic wave, the fluororesin was dissolved in the solvent. The resulting solution was used as a coating solution. In another example, a coating solution containing a terpolymer obtained from the monomers further containing an acrylic acid as a comonomer was produced.

For comparison, a coating solution containing a homopolymer obtained only from fluoroalkyl (meth)acrylate free of an unsaturated silane monomer, and a coating solution containing a copolymer obtained from fluoroalkyl (meth)acrylate free of an-unsaturated silane monomer and an acrylic acid (CH₂CH—C(═O)OH) were produced.

### Evaluation Procedure

a) Water-repellent and Oil-repellent Properties

The water-repellent and oil-repellent properties were evaluated based on the measurement of a stationary contact angle to the test solution. A previously cleaned glass plate of 76×16 mm was dipped in the coating solution (room temperature) prepared above, then quickly pulled up and dried to obtain a specimen. On the thus-obtained specimen, (i) pure water, (ii) silicone oil (KF-96-20 cp produced by Shin-Etsu Kagaku Kogyo K.K.) or (iii) n-hexadecane (produced by Wako Junyaku Kogyo K.K.) was dropped and the contact angle was measured at 25° C.

b) Water Resistance Test

The water resistance was evaluated by the dropping of water droplet. In the same manner as in a) above, a glass plate was partially dipped in the coating solution to obtain a partially coated specimen. This specimen was inclined at about 45° and from the portion about 5 mm upward the boundary between the area adhered with the coating film and the area not adhered with, 5 water droplets were continuously dropped using a syringe to allow the water droplets to run down toward the boundary. Then, the degree of the coating film peeled off was observed with a naked eye. It was observed that when a water droplet crawled under the film, the film was lifted like a scale and peeled off. In Table 1, when the film was peeled off, the specimen was rated x, and when not peeled off, the specimen was rated ▪.

c) Tests of Film-forming Property, Film Hardness and Adhesion Property

The film-forming property, film hardness and adhesive property were tested by the pencil scratch measurement according to JIS K5400 84.1 using a pencil scratch tester manufactured by Rikagaku Kogyo Sha. The load was 500 g.

### Example 1

Using F(CF₂)₆CH₂OC(═O)C(CH₃)═CH₂ (Component 1) as the fluoroaliphatic group-containing unsaturated ester monomer (Monomer A) and (C₂H₅O)₃SiCH═CH₂ (Component 10) as the unsaturated silane monomer (Monomer B), a coating solution was produced as described in General Procedure in Production of Coating Composition and coated on a glass plate as described above to form a coating film (Coating 1). The coating film obtained was evaluated on the physical properties. Also, from a monomer containing an acrylic acid (Component 12) as the comonomer (Monomer C) in addition to those monomers, a coating solution containing a terpolymer was produced according to the General Procedure described above and evaluated in the same manner (Coating 2). In Comparative Examples, a coating solution obtained by the polymerization of a monomer free of the unsaturated monomer (Monomer B), namely, a monomer consisting of Monomer A or monomers consisting of Monomers A and C, was used (Coating 3 and Coating 4, respectively). The coating formulations and results are shown in Table 1 below.

TABLE 1
Coating and Evaluation Thereof

| | | | 3 | 4 |
|---|---|---|---|---|
| Coating No. | 1 | 2 | (Comparison) | (Comparison) |
| Monomer A | Component 1 | Component 1 | Component 1 | Component 1 |
| (parts by weight) | 3.0 | 3.0 | 3.0 | 3.0 |
| Monomer B | Component 10 | Component 10 | — | — |
| (parts by weight) | 0.09 | 0.09 | | |
| Monomer C | — | Component 12 | — | Component 12 |
| (parts by weight) | | 0.09 | | 0.09 |
| Initiator | 0.09 | 0.09 | 0.09 | 0.09 |
| (parts by weight) | | | | |
| Solvent | 22 | 22 | 22 | 22 |
| (parts by weight) | | | | |
| Contact angle to | 118° | 111° | 117° | 114° |
| water | | | | |
| Contact angle to | — | — | — | — |
| silicone oil | | | | |
| Contact angle to | — | — | — | — |
| n-hexadecane | | | | |
| Pencil hardness | 2 B | 5 B | <6 B | <6 B |
| Water resistance | ▪ | ▪ | x | x |

### Example 2

Using C₇F₁₅SO₂N(C₂H₅)C₂H₄OC(═O)C(CH₃)═CH₂ (Component 2) as the fluoroaliphatic group-containing unsaturated ester monomer (Monomer A) and (C₂H₅O)₃SiCH═CH₂ (Component 10) as the unsaturated silane monomer (Monomer B), a coating solution was produced as described in General Procedure in Production of Coating Composition and coated on a glass plate as described above to form a coating film (Coating 5). The coating film obtained was evaluated on the physical properties. In Comparative Example, a coating solution obtained by the polymerization of a monomer free of the unsaturated monomer (Monomer B), namely, a monomer consisting of Monomer A, was used (Coating 6). The coating formulations and results are shown in Table 2 below.

### Example 3

Using c—C₆F₁₁CH₂OC(═O)C(CH₃)═CH₂ (Component 3) as the fluoroaliphatic group-containing unsaturated ester monomer (Monomer A) and (C₂H₅O)₃SiCH═CH₂ (Component 10) as the unsaturated silane monomer (Monomer B), a coating solution was produced as described in General Procedure in Production of Coating Composition and coated on a glass plate as described above to form a coating film (Coating 7). The coating film obtained was evaluated on the physical properties. In Comparative Examples, a coating solution obtained by the polymerization of a monomer free of the unsaturated monomer (Monomer B), namely, a monomer consisting of Monomer A was used (Coating 8), or a coating solution obtained by the polymerization of monomers free of the unsaturated monomer (Monomer B) and consisting of Monomer A and an acrylic acid (Component 12) as a comonomer (Monomer C) was used (Coating 9). The coating formulations and results are shown in Table 2 below.

TABLE 2
Coating and Evaluation Thereof (Cont.)

| | Example No. | | | | |
|---|---|---|---|---|---|
| | 2 | | 3 | | |
| | | 6 | | 8 | 9 |
| Coating No. | 5 | (Comparison) | 7 | (Comparison) | (Comparison) |
| Monomer A | Component | Component | Component | Component | Component |
| (parts by weight) | 2 | 2 | 3 | 3 | 3 |
| | 3.0 | 3.0 | 3.0 | 3.0 | 3.0 |
| Monomer B | Component | — | Component | — | — |
| (parts by weight) | 10 | | 10 | | |
| | 0.09 | | 0.09 | | |
| Monomer C | — | — | — | Component | |
| (parts by weight) | | | | 12 | |
| | | | | 0.09 | |
| Initiator | 0.09 | 0.09 | 0.09 | 0.09 | 0.09 |
| (parts by weight) | | | | | |
| Solvent) | 22 | 22 | 22 | 22 | |
| (parts by weight) | | | | | |
| Contact angle to | 110° | 109° | 106° | 104° | 105° |
| water | | | | | |
| Contact angle to | — | — | — | — | — |
| silicone oil | | | | | |
| Contact angle to | — | — | — | — | — |
| n-hexadecane | | | | | |
| Pencil hardness | 2 B | <6 B | 6 B | <6 B | <6 B |
| Water resistance | ▪ | x | ▪ | x | x |

### Example 4

Using C₆F₁₃C₂H₄OC(═O)CH═CH₂ (Component 4) as the fluoroaliphatic group-containing unsaturated ester monomer (Monomer A) and (C₂H₅O)₃SiCH═CH₂ (Component 10) as the unsaturated silane monomer (Monomer B), a coating solution was produced as described in General Procedure in Production of Coating Composition and coated on a glass plate as described above to form a coating film (Coating 10). The coating film obtained was evaluated on the physical properties. In Comparative Example, a coating solution obtained by the polymerization of a monomer free of the unsaturated monomer (Monomer B), namely, a monomer consisting of Monomer A was used (Coating 11). The coating formulations and results are shown in Table 3 below.

### Example 5

Using (CF₃)₂CF(CF₂)₂C₂H₄OC(═O)CH═CH₂ (Component 5) as the fluoroaliphatic group-containing unsaturated ester monomer (Monomer A) and (CH₃O)₃SiCH═CH₂ (Component 9), (C₂H₅O)₃SiCH═CH₂ (Component 10) or (CH₃O)₃SiCH₂CH═CH₂ (Component 11) as the unsaturated silane monomer (Monomer B), a coating solution was produced as described in General Procedure in Production of Coating Composition and coated on a glass plate as described above to form coating films (Coatings 12, 13 and 14, respectively). The coating films obtained were evaluated on the physical properties. In Comparative Example, a coating solution obtained by the polymerization of a monomer free of the unsaturated monomer (Monomer B), namely, a monomer consisting of Monomer A, was used (Coating 15). The coating formulations and results are shown in Table 3 below.

TABLE 3
Coating and Evaluation Thereof (Cont.)

| | Example No. | | | | | |
|---|---|---|---|---|---|---|
| | 4 | | 5 | | | |
| | | 11 | | | | 15 |
| Coating No. | 10 | (Comparison) | 12 | 13 | 14 | (Comparison) |
| Monomer A | Component | Component | Component | Component | Component | Component |
| (parts by weight) | 4 | 4 | 5 | 5 | 5 | 5 |
| | 3.0 | 3.0 | 3.0 | 3.0 | 3.0 | 3.0 |
| Monomer B | Component | — | Component | Component | Component | — |
| (parts by weight) | 10 | | 10 | 9 | 11 | |
| | 0.30 | | 0.3 | 0.3 | 0.3 | |
| Monomer C | — | — | — | — | — | — |
| (parts by weight) | | | | | | |
| Initiator | 0.09 | 0.09 | 0.09 | 0.09 | 0.09 | 0.09 |
| (parts by weight) | | | | | | |
| Solvent | 22 | 22 | 22 | 22 | 22 | 22 |
| (parts by weight) | | | | | | |
| Contact angle to | 119° | 116° | 116° | 119° | 119° | 122° |
| water | | | | | | |
| Contact angle to | — | — | — | — | — | — |
| silicone oil | | | | | | |
| Contact angle to | — | — | — | — | — | — |
| n-hexadecane | | | | | | |
| Pencil hardness | — | — | 2 H | 9 H | 9 H | 6 B |
| Water resistance | ▪ | x | ▪ | ▪ | ▪ | ▪ |

### Example 6

Using H(CF₂)₄CH₂OC(═O)CH═CH₂ (Component 6) as the fluoroaliphatic group-containing unsaturated ester monomer (Monomer A) and (C₂H₅O)₃SiCH═CH₂ (Component 10) as the unsaturated silane monomer (Monomer B), a coating solution was produced as described in General Procedure in Production of Coating Composition and coated on a glass plate as described above to form a coating film (Coating 16). In Comparative Example, a coating solution obtained by the polymerization of a monomer free of the unsaturated monomer (Monomer B), namely, a monomer consisting of Monomer A, was used (Coating 17). The coating formulations and results are shown in Table 4 below.

### Example 7

Using F(CF₂)₄C₂H₄OC(═O)CH═CH₂ (Component 7) as the fluoroaliphatic group-containing unsaturated ester monomer (Monomer A) and (C₂H₅O)₃SiCH═CH₂ (Component 10) as the unsaturated silane monomer (Monomer B), a coating solution was produced as described in General Procedure in Production of Coating Composition and coated on a glass plate as described above to form a coating film (Coating 18). The coating film obtained was evaluated on the physical properties. In Comparative Example, a coating solution obtained by the polymerization of a monomer free of the unsaturated monomer (Monomer B), namely, a monomer consisting of Monomer A, was used (Coating 19). The coating formulations and results are shown in Table 4 below.

TABLE 4
Coating and Evaluation Thereof (Cont.)

| | Example No. | | | |
|---|---|---|---|---|
| | 6 | | 7 | |
| | | 17 | | 19 |
| | | (Compar- | | (Compar- |
| Coating No. | 16 | ison) | 18 | ison) |
| Monomer A | Component | Component | Component | Component |
| (parts by | 6 | 6 | 7 | 7 |
| weight) | 3.0 | 3.0 | 3.0 | 3.0 |
| Monomer B | Component | — | Component | — |
| (parts by | 10 | | 10 | |
| weight) | 0.3 | | 0.15 | |
| Monomer C | — | — | — | — |
| (parts by | | | | |
| weight) | | | | |
| Initiator | 0.09 | 0.09 | 0.09 | 0.09 |
| (parts by | | | | |
| weight) | | | | |
| Solvent | 22 | 22 | 22 | 22 |
| (parts by | | | | |
| weight) | | | | |
| Contact angle | 96° | 94° | 116° | 100° |
| to water | | | | |
| Contact angle | — | — | — | — |
| silicone oil | | | | |
| Contact angle | — | — | — | — |
| to | | | | |
| n-hexadecane | | | | |
| Pencil hardness | 3 B | <6 B | 3 B | 6 B |
| Water | — | — | ▪ | ▪ |
| resistance | | | | |

### Example 8

Using F(CF₂)₃CH₂OC(═O)CH═CH₂ (Component 8) as the fluoroaliphatic group-containing unsaturated ester monomer (Monomer A) and (C₂H₅O)₃SiCH═CH₂ (Component 10) as the unsaturated silane monomer (Monomer B), a coating solution was produced as described in General Procedure in Production of Coating Composition and coated on a glass plate as described above to form a coating film (Coating 20). In Comparative Example, a coating solution obtained by the polymerization of a monomer free of the unsaturated monomer (Monomer B), namely, a monomer consisting of Monomer A, was used (Coating 21). The coating formulations and results are shown in Table 5 below.

TABLE 5
Coating and Evaluation Thereof (Cont.)

Example No.
8

| Coating No. | 20 | 21 (Comparison) |
|---|---|---|
| Monomer A | Component 8 | Component 8 |
| (parts by weight) | 3.0 | 3.0 |
| Monomer B | Component 10 | — |
| (parts by weight) | 0.15 | |
| Monomer C | — | — |
| (parts by weight) | | |
| Initiator | 0.09 | 0.09 |
| (parts by weight) | | |
| Solvent | 22 | 22 |
| (parts by weight) | | |
| Contact angle to water | 116° | 119° |
| Contact angle to silicone oil | — | — |
| Contact angle to n-hexadecane | — | — |
| Pencil hardness | 4 H | 5 H |
| Water resistance | ▪ | x |

### Example 9

Using (CF₃)₂CF(CF₂)₂C₂H₄OC(═O)CH═CH₂ (Component 5) as the fluoroaliphatic group-containing unsaturated ester monomer (Monomer A) and (CH₃O)₃SiCH═CH₂ (Component 9) in four varied amounts as the unsaturated silane monomer (Monomer B), a coating solution was produced as described in General Procedure in Production of Coating Composition and coated on a glass plate as described above to form coating films (Coatings 22, 23, 24 and 25, respectively). In Comparative Example, a coating solution obtained by the polymerization of a monomer free of the unsaturated monomer (Monomer B), namely, a monomer consisting of Monomer A, was used (Coating 26). The coating formulations and results are shown in Table 6 below.

TABLE 6
Coating and Evaluation Thereof (Cont.)

| | Example No. | | | | |
|---|---|---|---|---|---|
| | 9 | | | | |
| | | | | | 26 |
| Coating No. | 22 | 23 | 24 | 25 | (Comparison) |
| Monomer A | Component | Component | Component | Component | Component |
| (parts by weight) | 5 | 5 | 5 | 5 | 5 |
| | 3.0 | 3.0 | 3.0 | 3.0 | 3.0 |
| Monomer B | Component | Component | Component | Component | — |
| (parts by weight) | 9 | 9 | 9 | 9 | |
| | 0.3 | 0.2 | 0.1 | 0.05 | |
| Monomer C | — | — | — | — | — |
| (parts by weight) | | | | | |
| Initiator | 0.09 | 0.09 | 0.09 | 0.09 | 0.09 |
| (parts by weight) | | | | | |
| Solvent | 22 | 22 | 22 | 22 | 22 |
| (parts by weight) | | | | | |
| Contact angle to | 119° | 121° | 123° | 123° | 122° |
| water | | | | | |
| Contact angle to | 60° | 66° | 68° | 72° | 57° |
| silicone oil | | | | | |
| Contact angle to | 79° | 78° | 81° | 83° | — |
| n-hexadecane | | | | | |
| Pencil hardness | 9 H | 9 H | 8 H | H | 6 B |
| Water resistance | ▪ | ▪ | ▪ | ▪ | ▪ |

### Example 10

Using F(CF₂)₃CH₂OC(═O)CH═CH₂ (Component 8) as the fluoroaliphatic group-containing unsaturated ester monomer (Monomer A) and (CH₃O)₃SiCH₂CH═CH₂ (Component 11) in four varied amounts as the unsaturated silane monomer (Monomer B), a coating solution was produced as described in General Procedure in Production of Coating Composition and coated on a glass plate as described above to form coating films (Coatings 27, 28, 29 and 30, respectively). In Comparative Example, a coating solution obtained by the polymerization of a monomer free of the unsaturated monomer (Monomer B), namely, a monomer consisting of Monomer A, was used (Coating 31). The coating formulations and results are shown in Table 7 below.

TABLE 7
Coating and Evaluation Thereof (Cont.)

| | Example No. | | | | |
|---|---|---|---|---|---|
| | 10 | | | | |
| | | | | | 31 |
| Coating No. | 27 | 28 | 29 | 30 | (Comparison) |
| Monomer A | Component | Component | Component | Component | Component |
| (parts by weight) | 8 | 8 | 8 | 8 | 8 |
| | 3.0 | 3.0 | 3.0 | 3.0 | 3.0 |
| Monomer B | Component | Component | Component | Component | — |
| (parts by weight) | 11 | 11 | 11 | 11 | |
| | 0.3 | 0.2 | 0.1 | 0.05 | |
| Monomer C | — | — | — | — | — |
| (parts by weight) | | | | | |
| Initiator | 0.09 | 0.09 | 0.09 | 0.09 | 0.09 |
| (parts by weight) | | | | | |
| Solvent | 22 | 22 | 22 | 22 | 22 |
| (parts by weight) | | | | | |
| Contact angle to | 116° | 118° | 122° | 121° | 120° |
| water | | | | | |
| Contact angle to | 65° | 68° | 70° | 74° | 69° |
| silicone oil | | | | | |
| Contact angle to | 71° | 75° | 80° | 83° | 76° |
| n-hexadecane | | | | | |
| Pencil hardness | 4 H | H | 3 B | 4 B | 5 B |
| Water resistance | ▪ | ▪ | ▪ | ▪ | ▪ |

In the Tables, Monomer A is a fluoroalkyl-containing unsaturated ester monomer, Monomer B is a silane unsaturated monomer and Monomer C is a comonomer (acrylic acid). The initiator is azobisisobutyronitrile and the solvent is n—C₄F₉OC₂H₅.

Monomer A:

Component 1: F(CF₂)₆CH₂OC(═O)C(CH₃)═CH₂

Component 2: C₇F₁₅SO₂N(C₂H₅)C₂H₄OC(═O)C(CH₃)═CH₂

Component 3: c—C₆F₁₁CH₂OC(═O)C(CH₃)═CH₂

Component 4: C₆F₁₃C₂H₄OC(═O)CH═CH₂

Component 5: (CF₃)₂CF(CF₂)₂C₂H₄OC(═O)CH═CH₂

Component 6: H(CF₂)₄CH₂OC(O)CH═CH₂

Component 7: F(CF₂)₄C₂H₄OC(═O)CH═CH₂

Component 8: F(CF₂)₃CH₂OC(═O)CH═CH₂

Monomer B

Component 9: (CH₃O)₃SiCH═CH₂

Component 10: (C₂H₅O)₃SiCH═CH₂

Component 11: (CH₃O)₃SiCH₂CH═CH₂

Monomer C

Component 12: acrylic acid

From the results shown above, it is seen that the coating film formed of the coating composition of the present invention using a copolymer containing an unsaturated silane monomer has a contact angle (to water, silicone oil or n-hexadecane) equal to or greater than that of the coating film formed of a conventional coating composition using a copolymer free of an unsaturated silane monomer. At the same time, it also has high pencil hardness and water resistance (see, for example, Examples 1 to 10, particularly Examples 1, 9 and 10). Thus, the coating composition of the present invention is verified to ensure improved adhesion property to a substrate while maintaining the water repellency/oil repellency equal to or greater than that of conventional coating compositions. Furthermore, as seen from the results of Coating 2 of Example 1, even when a copolymer containing another comonomer such as acrylic acid in addition to the fluoroaliphatic group-containing unsaturated ester monomer (Monomer A) and unsaturated silane monomer (Monomer B) is used, the pencil hardness and water resistance are improved and the adhesive property to a substrate is increased. Also, even when the amount of the unsaturated silane monomer added is as small as 1 wt % or slightly larger than that, the coating film obtained is significantly improved in the pencil hardness (adhesion property to a substrate) (see, Example 9, Coatings 25 and 26, etc.).

What is claimed:

1. A coating composition comprising a copolymer obtained by copolymerizing monomers comprising a fluoroaliphatic group-containing unsaturated ester monomer and an unsaturated silane monomer.

2. The coating composition as claimed in claim 1, wherein said unsaturated silane monomer is selected from the group consisting of vinyltrimethoxysilane, vinyltriethoxysilane, vinyltriisopropoxysilane and vinyl-tert-butoxysilane.

3. The coating composition as claimed in claim 1 or 2, wherein said unsaturated silane monomer is contained in an amount of 1 to 50 wt % based on the total weight of said fluoroaliphatic group-containing unsaturated ester monomer and said unsaturated silane monomer.

4. The coating composition as claimed in any one of claims 1 to 3, further comprising a hydrofluorocarbon ether or a hydrofluorocarbon.

5. An article comprising a substrate having a surface and a coating on at least a portion of said surface that comprises the copolymerized product of a fluoroaliphatic group-containing unsaturated ester monomer and an unsaturated silane monomer.
